(19) United States
(12) Patent Application Publication
(10) Pub. No.: US 2026/0183878 A1
(43) Pub. Date: Jul. 2, 2026

(54) NUT PRESS-FITTING STRUCTURE

(71) Applicant: Yazaki Corporation, Tokyo (JP)

(72) Inventor: Takumi MIZOBE, Shizuoka (JP)

(73) Assignee: Yazaki Corporation, Tokyo (JP)

(21) Appl. No.: 19/430,484

(22) Filed: Dec. 23, 2025

(30) Foreign Application Priority Data
Dec. 26, 2024 (JP) 2024-230066

(51) Int. Cl. B23P 19/02

(52) U.S. Cl. CPC B23P 19/02

(57) ABSTRACT

A nut press-fitting structure includes a housing having a press-fitting recess to which a nut can be press-fitted, the press-fitting recess having the inner wall surface and a press-fitting rib. The first rib is provided on the front side in the press-fitting direction with respect to the second rib, and the protrusion amount from the inner wall surface is formed to be smaller than the protrusion amount from the inner wall surface of the second rib, and the second rib is provided on the back side in the press-fitting direction with respect to the first rib, and the protrusion amount from the inner wall surface is formed to be larger than the protrusion amount from the inner wall surface of the first rib.

### CROSS-REFERENCE TO RELATED APPLICATION(S)

The present application claims priority to and incorporates by reference the entire contents of Japanese Patent Application No. 2024-230066 filed in Japan on Dec. 26, 2024.

### BACKGROUND OF THE INVENTION

### 1. Field of the Invention

The present invention relates to a nut press-fitting structure.

### 2. Description of the Related Art

For example, JP 2021-114 441 A discloses an electrical connection component including a nut, a housing having a press-fitting groove (press-fitting recess) into which the nut is press-fitted, and a rib formed on an inner side surface of the press-fitting recess and in pressing contact with the nut.

In the nut press-fitting structure applied to the electrical connection component described in JP 2021-114 441 A described above, there is a possibility that the position of the nut is shifted before the nut comes into contact with the rib at the time of press-fitting the nut into the press-fitting recess, and thus there is room for further improvement in terms of workability.

### SUMMARY OF THE INVENTION

The present invention has been made in view of the above circumstances, and an object thereof is to provide a nut press-fitting structure capable of improving workability at the time of press-fitting a nut.

In order to achieve the above mentioned object, a nut press-fitting structure according to one aspect of the present invention includes a housing having a press-fitting recess to which a nut can be press-fitted along a press-fitting direction, wherein the press-fitting recess includes; an inner wall surface raised along the press-fitting direction, and a press-fitting rib formed along the press-fitting direction on the inner wall surface and interposed between the press-fitted nut and the inner wall surface; the press-fitting rib includes a first rib and a second rib; the first rib is provided on a front side of the second rib in the press-fitting direction, and is formed so that a protrusion amount from the inner wall surface is smaller than a protrusion amount from the inner wall surface of the second rib; and the second rib is provided on a back side in the press-fitting direction with respect to the first rib, and is formed so that a protrusion amount from the inner wall surface is larger than a protrusion amount from the inner wall surface of the first rib.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a schematic configuration of a terminal block to which a nut press-fitting structure according to the present embodiment is applied;

FIG. 2 is a perspective view schematically illustrating the nut press-fitting structure according to the present embodiment;

FIG. 3 is an enlarged view of a press-fitting rib illustrated in FIG. 2;

FIG. 4 is a top view schematically illustrating the nut press-fitting structure according to the present embodiment; and

FIG. 5 is an enlarged view of the press-fitting rib illustrated in FIG. 4.

### DETAILED DESCRIPTION OF THE PREFERRED EMBODIMENTS

Hereinafter, an embodiment according to the present invention will be described in detail with reference to the drawings. Note that the present invention is not limited by the embodiment. In addition, constituent elements in the following embodiment include those that can be easily replaced by those skilled in the art or those that are substantially the same.

### Embodiment

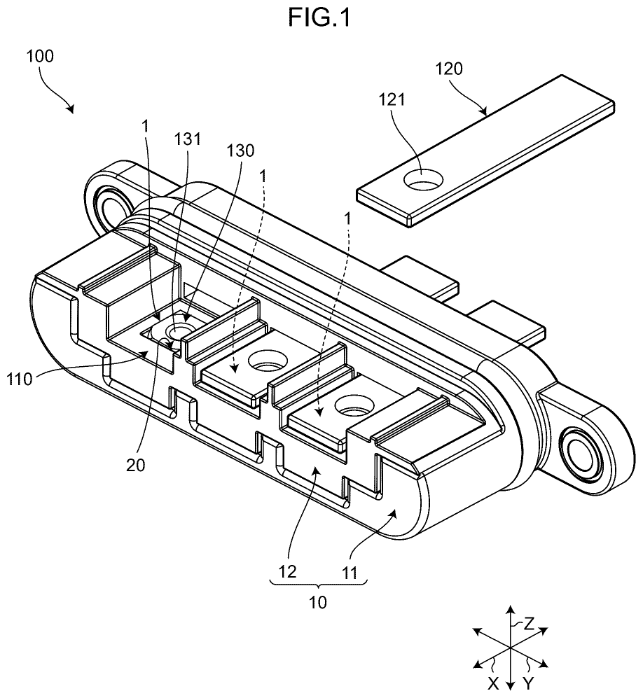

As illustrated in FIG. 1, a nut press-fitting structure 1 according to the present embodiment is applied to a conduction fixing portion 110 of a terminal block 100. The terminal block 100 referred to herein is, for example, mounted on a vehicle such as an automobile, and relays electrical connection between devices such as a motor and an inverter. In addition, the conduction fixing portion 110 is a portion where a conduction member 120 is disposed adjacent to a nut 130 press-fitted into a housing 10, and is a portion where the conduction member 120 and a connection counterpart member (not illustrated) conductively connected to the conduction member 120 are fixed by a bolt (not illustrated) and the nut 130.

The conduction member 120 is a member having conductivity, and is, for example, a bus bar formed of a metal material in a plate shape. The conduction member 120 is formed with a bolt insertion hole 121 through which a shaft portion of a bolt to be fastened to the nut 130 is inserted.

Each of the bolt (not illustrated) and the nut 130 is a member having conductivity, and is, for example, a fastening member formed of a metal material. As illustrated in FIG. 1 and the like, the nut 130 of the present embodiment is a square nut, and is formed in a substantially rectangular shape as viewed along the thickness direction. A bolt fastening hole 131 is formed in the nut 130. The nut 130 can fasten the conduction member 120 and the connection counterpart member sandwiched between the nut and the bolt by fastening the shaft portion of the bolt to the bolt fastening hole 131.

Note that in the terminal block 100 illustrated in FIG. 1, three sets of conduction fixing portions 110 are illustrated, and the nut press-fitting structure 1 is provided in each of the three conduction fixing portions 110. Furthermore, in the nut press-fitting structure 1, the nut 130 described above is press-fitted into a press-fitting recess 20 formed in the housing 10. In the press-fitting recess 20, a press-fitting rib 30 for holding the press-fitted nut 130 is provided along the press-fitting direction. In such a configuration, the nut press-fitting structure 1 of the present embodiment realizes a configuration in which workability at the time of press-fitting the nut 130 can be improved by configuring the press-fitting rib 30 provided in the press-fitting recess 20 by two ribs having different sizes, that is, a small first rib 31 located on the front side in the press-fitting direction and a large second rib 32 located on the back side in the press-fitting direction. Hereinafter, each configuration of the nut press-fitting structure 1 will be described in detail with reference to FIGS. 1 to 5 and the like.

Note that FIG. 1 is an exploded perspective view visualizing the position of the nut press-fitting structure 1 applied to the conduction fixing portion 110 of the terminal block 100 by illustrating a state in which only one conduction member 120 is disassembled.

In the following description, among a first direction, a second direction, and a third direction intersecting each other, the first direction is referred to as a “first width direction X”, the second direction is referred to as a “second width direction Y”, and the third direction is referred to as a “press-fitting direction Z”. Here, the first width direction X, the second width direction Y, and the press-fitting direction Z are orthogonal to each other. Furthermore, the first width direction X typically corresponds to a depth direction of the terminal block 100, an extending direction of the conduction member 120, and the like. The second width direction Y corresponds to a width direction of the terminal block 100, a width direction of the conduction member 120, and the like. The press-fitting direction Z corresponds to a height direction of the terminal block 100, a thickness direction of the conduction member 120, a press-fitting direction of the nut 130 with respect to the press-fitting recess 20, an extending direction of the press-fitting rib 30 provided in the press-fitting recess 20, a fastening direction of a bolt with respect to the nut 130 press-fitted into the press-fitting recess 20, and the like. In addition, each direction used in the following description represents a direction in a state in which each part is assembled to each other unless otherwise specified.

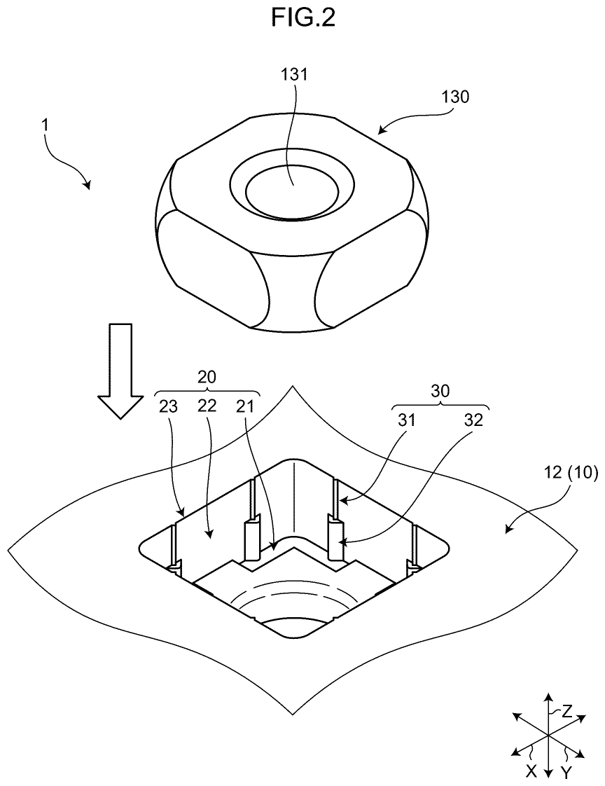

As illustrated in FIGS. 1 and 2, the nut press-fitting structure 1 includes the housing 10 having a press-fitting recess 20 to which the nut 130 can be press-fitted along the press-fitting direction Z.

The housing 10 is a member that is formed of, for example, a resin material having insulation property, and that holds the nut 130 accommodated in the press-fitting recess 20. As illustrated in FIG. 1, the housing 10 of the present embodiment is configured by combining a plurality of members by way of an example, and includes a housing main body 11 attached to an attachment object and a front holder 12 for supporting the conduction member 120 conductively connected to the connection counterpart member by being assembled to the housing main body 11. The press-fitting recess 20 is provided in the front holder 12, and three press-fitting recesses 20 are formed on the upper surface of the front holder 12 (the surface on the side opposite to the side where the housing main body 11 is located). Here, the three press-fitting recesses 20 are located side by side at intervals along the second width direction Y.

As illustrated in FIG. 2, the press-fitting recess 20 includes a bottom surface 21, an inner wall surface 22, and an opening 23. The bottom surface 21 is a substantially rectangular wall surface extending along the first width direction X and the second width direction Y, and is a wall surface located to face the opening 23 along the press-fitting direction Z. Furthermore, the inner wall surface 22 is a substantially rectangular wall surface raised along the press-fitting direction Z from each side of the bottom surface 21. The opening 23 is an opening formed by being surrounded by an edge portion of the inner wall surface 22 (an edge portion located on a side opposite to the bottom surface 21 in the press-fitting direction Z) and formed to a size into which the nut 130 can be inserted. The inner wall surface 22 of the present embodiment is raised along the press-fitting direction Z from four sides of the bottom surface 21 formed in a substantially rectangular shape. Therefore, in the present embodiment, four inner wall surfaces 22 are provided, and the four inner wall surfaces 22 are arranged in a rectangular frame shape when viewed from the press-fitting direction Z. Among the four inner wall surfaces 22, two inner wall surfaces 22 are extended along the first width direction X and the press-fitting direction Z, and are located to face each other in the second width direction Y. The remaining two inner wall surfaces 22 are extended along the second width direction Y and the press-fitting direction Z, and are located to face each other in the first width direction X. Furthermore, the opening 23 is formed in a substantially rectangular shape by the edge portions of the four inner wall surfaces 22. Therefore, the press-fitting recess 20 of the present embodiment is formed as a substantially rectangular column recess-shaped space portion by the bottom surface 21, the four inner wall surfaces 22, and the opening 23.

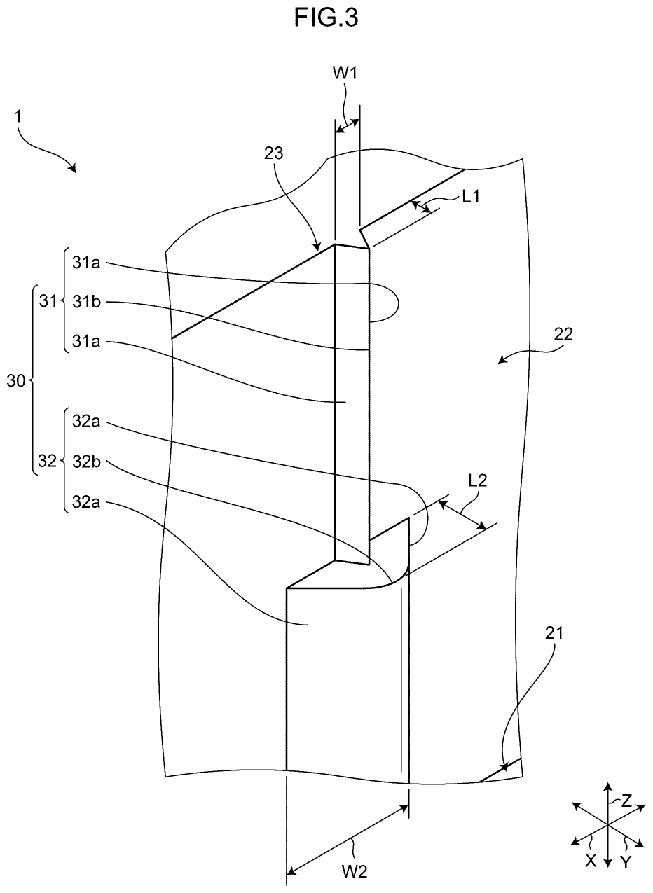

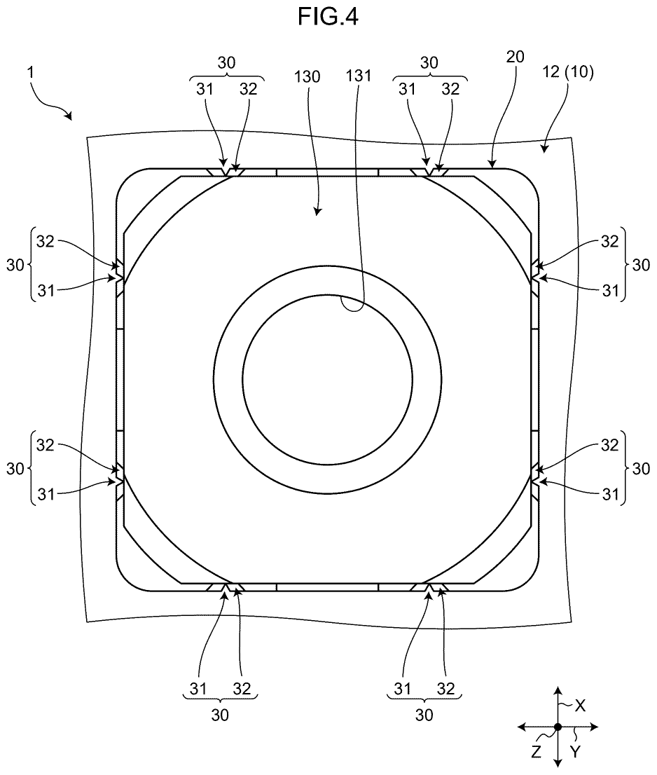

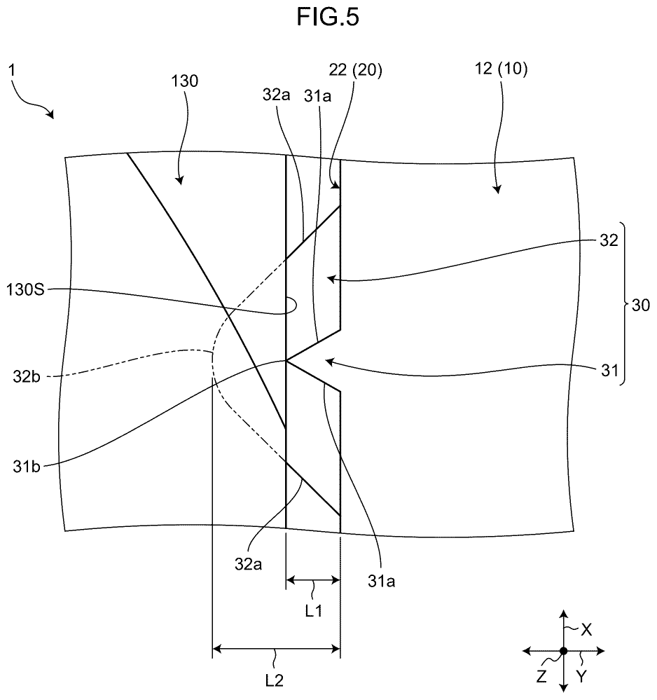

In addition, as illustrated in FIGS. 2 and 3, the press-fitting recess 20 includes a press-fitting rib 30 formed linearly along the press-fitting direction Z on the inner wall surface 22. Two press-fitting ribs 30 are formed on each of the four inner wall surfaces 22 constituting the press-fitting recess 20 (see FIG. 4). That is, eight press-fitting ribs 30 are provided in each press-fitting recess 20, and among the eight press-fitting ribs 30, the four press-fitting ribs 30 provided on a pair of inner wall surfaces 22 extending in the first width direction X when viewed from the press-fitting direction Z are located to face each other in the second width direction Y. Furthermore, the four press-fitting ribs 30 provided on a pair of inner wall surfaces 22 extending in the second width direction Y when viewed from the press-fitting direction Z are located to face each other in the first width direction X. Each of the eight press-fitting ribs 30 is interposed between the nut 130 press-fitted into the press-fitting recess 20 and the inner wall surface 22 (See FIGS. 4 and 5).

As illustrated in FIGS. 2 and 3, the press-fitting rib 30 of the present embodiment includes a first rib 31 and a second rib 32. The press-fitting rib 30 is formed as one rib by continuously forming the first rib 31 and the second rib 32 along the press-fitting direction Z.

As illustrated in FIGS. 2 and 3, the first rib 31 is provided in front of the second rib 32 in the press-fitting direction Z, that is, on the opening 23 side. The first rib 31 is formed from an edge portion of the inner wall surface 22 forming the opening 23 toward the press-fitting direction Z. The first rib 31 is formed to protrude from the inner wall surface 22 toward the inward side of the press-fitting recess 20 and to protrude along the direction intersecting the inner wall surface 22.

In addition, as illustrated in FIGS. 3 and 5, the first rib 31 has a triangular cross-sectional shape when viewed from the press-fitting direction Z, and includes a pair of inclined surfaces 31a formed by a flat surface and a vertex 31b located between the pair of inclined surfaces 31a.

Furthermore, as illustrated in FIG. 3, the first rib 31 is formed such that a protrusion amount L1 from the inner wall surface 22 is smaller than a protrusion amount L2 from the inner wall surface 22 of the second rib 32 in a state before the nut 130 is press-fitted into the press-fitting recess 20. In addition, as illustrated in FIG. 3, the first rib 31 is formed such that a width W1 along a direction intersecting the press-fitting direction Z is smaller than a width W2 along a direction intersecting the press-fitting direction Z of the second rib 32. Therefore, the first rib 31 is formed to have a relatively small cross-sectional shape as viewed from the press-fitting direction Z as compared with the second rib 32.

On the other hand, as illustrated in FIGS. 2 and 3, the second rib 32 is provided on the back side in the press-fitting direction Z, that is, on the bottom surface 21 side with respect to the first rib 31. The second rib 32 is formed to protrude from the inner wall surface 22 toward the inward side of the press-fitting recess 20 and to protrude along the direction intersecting the inner wall surface 22.

In addition, as illustrated in FIG. 3, the second rib 32 has a substantially triangular cross-sectional shape when viewed from the press-fitting direction Z, and includes a pair of inclined surfaces 32a formed by a flat surface and a top surface 32b located between the pair of inclined surfaces 32a and formed of a curved surface.

Furthermore, as described above, the second rib 32 is formed such that the protrusion amount L2 from the inner wall surface 22 is larger than the protrusion amount L1 from the inner wall surface 22 of the first rib 31 in a state before the nut 130 is press-fitted into the press-fitting recess 20. The width W2 of the second rib 32 along the direction intersecting the press-fitting direction Z is larger than the width W1 of the first rib 31 along the direction intersecting the press-fitting direction Z. Therefore, the second rib 32 is formed to have a relatively large cross-sectional shape as viewed from the press-fitting direction Z as compared with the first rib 31.

In addition, as illustrated in FIG. 5, the protrusion amount L1 of the first rib 31 configured as described above is set such that the vertex 31b of the first rib 31 comes into contact with an outer surface 130S of the nut 130 when the nut 130 is press-fitted into the press-fitting recess 20 (see FIG. 5). In other words, in the protrusion amount L1 of the first rib 31, the interval between the pair of first ribs 31 facing each other along the first width direction X (or the second width direction Y) is set to be substantially equal to the width of the nut 130 along the first width direction X (or the second width direction Y). Therefore, the first rib 31 of the present embodiment can function as a guide rib that corrects the position of the nut 130 in order to hold the nut 130 press-fitted into the press-fitting recess 20 at an appropriate position in the press-fitting recess 20.

Furthermore, as illustrated in FIG. 5, the protrusion amount L2 of the second rib 32 is set such that the top surface 32b of the second rib 32 is scraped by the nut 130 by coming into pressing contact with the outer surface 130S of the nut 130 when the nut 130 is press-fitted into the press-fitting recess 20. In other words, in the protrusion amount L2 of the second rib 32, the interval between the pair of second ribs 32 facing each other along the first width direction X (or the second width direction Y) is set to be smaller than the width of the nut 130 along the first width direction X (or the second width direction Y). Therefore, the second rib 32 of the present embodiment can function as a crushing rib that is plastically deformed and scraped by the nut 130 while guiding the nut 130 press-fitted into the press-fitting recess 20 along the press-fitting direction Z. In addition, the second rib 32 can function as a pressing rib that generates a frictional force for holding the nut 130 press-fitted to the innermost depth part of the press-fitting recess 20 in the press-fitting recess 20.

The nut press-fitting structure 1 described above includes the housing 10 having the press-fitting recess 20 to which the nut 130 can be press-fitted along the press-fitting direction Z, the press-fitting recess 20 having the inner wall surface 22 raised along the press-fitting direction Z and the press-fitting rib 30 formed on the inner wall surface 22 along the press-fitting direction Z and interposed between the press-fitted nut 130 and the inner wall surface 22, and the press-fitting rib 30 including the first rib 31 and the second rib 32. Furthermore, the first rib 31 is provided on the front side in the press-fitting direction Z with respect to the second rib 32, and the protrusion amount L1 from the inner wall surface 22 is formed to be smaller than the protrusion amount L2 from the inner wall surface 22 of the second rib 32, and the second rib 32 is provided on the back side in the press-fitting direction Z with respect to the first rib 31, and the protrusion amount L2 from the inner wall surface 22 is formed to be larger than the protrusion amount L1 from the inner wall surface 22 of the first rib 31.

According to such a configuration, in the nut press-fitting structure 1, at the time of press-fitting the nut 130 into the press-fitting recess 20, first, the nut 130 comes into contact with the first rib 31 having a small protrusion amount, so that the nut 130 can be lightly press-fitted, and the position of the nut 130 can be corrected by the first rib 31. In the nut press-fitting structure 1, the nut 130 is further press-fitted toward the back in a state where the position of the nut 130 is corrected by the first rib 31, and the nut 130 comes into contact with the second rib 32 having a large protrusion amount, so that the nut 130 can be actually press-fitted at an appropriate position in the press-fitting recess 20. Therefore, in the nut press-fitting structure 1 of the present embodiment, the positional shift of the nut 130 that occurs at the time of press-fitting can be suppressed by providing the first rib 31 in front of the second rib 32. Therefore, the nut press-fitting structure 1 of the present embodiment can improve workability at the time of press-fitting the nut 130.

Furthermore, in the nut press-fitting structure 1, since the position of the nut 130 can be corrected by the first rib 31, a jig for correcting the position of the nut 130 does not need to be separately prepared, and for example, the nut 130 can be press-fitted to an appropriate position in the press-fitting recess 20 by pressing the nut 130 temporarily placed manually by the worker into the press-fitting recess 20 as it is. Therefore, the nut press-fitting structure 1 of the present embodiment can reduce the working man-hour at the time of press-fitting the nut 130 and simplify the work procedure, thereby further improving workability.

Furthermore, in the press-fitting rib 30 described above, the first rib 31 and the second rib 32 are continuously formed along the press-fitting direction Z. According to such a configuration, in the nut press-fitting structure 1, since the first rib 31 and the second rib 32 are connected and formed, the nut 130 can be more smoothly press-fitted into the press-fitting recess 20. Therefore, the nut press-fitting structure 1 of the present embodiment can further suppress the positional shift of the nut 130 that occurs at the time of press-fitting. Therefore, the nut press-fitting structure 1 of the present embodiment can further improve workability at the time of press-fitting the nut 130.

Furthermore, in the first rib 31 described above, the width W1 along the direction intersecting the press-fitting direction Z is formed to be smaller than the width W2 along the direction intersecting the press-fitting direction Z of the second rib 32, and in the second rib 32, the width W2 along the direction intersecting the press-fitting direction Z is formed to be larger than the width W1 along the direction intersecting the press-fitting direction Z of the first rib 31. According to such a configuration, in the nut press-fitting structure 1, since the protrusion amount L1 and the width W1 of the first rib 31 are formed to be smaller than the protrusion amount L2 and the width W2 of the second rib 32, the nut 130 can be press-fitted with a lighter force and the nut 130 can be held with a lighter force. In addition, in the nut press-fitting structure 1, since the protrusion amount L2 and the width W2 of the second rib 32 are formed to be larger than the protrusion amount L1 and the width W1 of the first rib 31, the nut 130 can be press-fitted with a stronger force and the nut 130 can be held with a stronger force. Therefore, in the nut press-fitting structure 1 of the present embodiment, the positional shift of the nut 130 after the actual press-fitting can be further suppressed by the second rib 32. Therefore, the nut press-fitting structure 1 of the present embodiment can further improve workability at the time of press-fitting the nut 130.

Furthermore, the inner wall surface 22 described above is arranged in a rectangular frame shape when viewed from the press-fitting direction Z, and the press-fitting rib 30 is provided on each of the inner wall surfaces 22 located facing each other. According to such a configuration, since the press-fitting ribs 30 located facing each other are located so as to sandwich the nut 130, the nut 130 can be press-fitted into the press-fitting recess 20 in a stable posture. Therefore, the nut press-fitting structure 1 of the present embodiment can further suppress the positional shift of the nut 130 that occurs at the time of press-fitting. Therefore, the nut press-fitting structure 1 of the present embodiment can further improve workability at the time of press-fitting the nut 130.

Note that the nut press-fitting structure 1 is not limited to the above-described embodiment, and various modifications can be made within the scope described in the claims.

For example, in the above description, the nut press-fitting structure 1 has been described as being applied to the terminal block 100, but may be applied to a structure (e.g., an electrical connection box) that relays electrical connection between devices mounted on a vehicle.

Furthermore, the first rib 31 and the second rib 32 may be formed at intervals along the press-fitting direction Z.

Moreover, the positions of the first rib 31 and the second rib 32 with respect to the width direction (in the present embodiment, the first width direction X or the second width direction Y) of the inner wall surface 22 may not be aligned, and the first rib and the second rib may be formed at positions shifted with respect to the width direction.

The shapes of the first rib 31 and the second rib 32 are not limited to the form illustrated in FIG. 3 and the like.

The width W1 of the first rib 31 may be formed smaller than the width W2 of the second rib 32.

In addition, the shape of the press-fitting recess 20 viewed from the press-fitting direction Z is not particularly limited, and can be set in accordance with the shape of the nut 130 to be press-fitted into the press-fitting recess 20.

The number of the press-fitting ribs 30 provided on the inner wall surface 22 of the press-fitting recess 20 and the position of the press-fitting rib 30 are not particularly limited.

In the above description, description has been made that the housing 10 is configured by combining two members of the housing main body 11 and the front holder 12, and the press-fitting recess 20 is provided in the housing main body 11, but the housing 10 may be configured by one member and the press-fitting recess 20 may be provided in that member.

In addition, the nut press-fitting structure 1 according to the present embodiment may be configured by appropriately combining the constituent elements of the embodiment described above.

A nut press-fitting structure according to the present embodiment has an effect that workability at the time of press-fitting the nut can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A nut press-fitting structure comprising:
a housing having a press-fitting recess to which a nut can be press-fitted along a press-fitting direction, wherein
the press-fitting recess includes;
an inner wall surface raised along the press-fitting direction, and
a press-fitting rib formed along the press-fitting direction on the inner wall surface and interposed between the press-fitted nut and the inner wall surface;
the press-fitting rib includes a first rib and a second rib;
the first rib is provided on a front side of the second rib in the press-fitting direction, and is formed so that a protrusion amount from the inner wall surface is smaller than a protrusion amount from the inner wall surface of the second rib; and
the second rib is provided on a back side in the press-fitting direction with respect to the first rib, and is formed so that a protrusion amount from the inner wall surface is larger than a protrusion amount from the inner wall surface of the first rib.

2. The nut press-fitting structure according to claim 1, wherein
in the press-fitting rib, the first rib and the second rib are continuously formed along the press-fitting direction.

3. The nut press-fitting structure according to claim 1, wherein
the first rib is formed with a width along a direction intersecting the press-fitting direction smaller than a width of the second rib along a direction intersecting the press-fitting direction; and
the second rib is formed with a width along a direction intersecting the press-fitting direction larger than a width of the first rib along a direction intersecting the press-fitting direction.

4. The nut press-fitting structure according to claim 2, wherein
the first rib is formed with a width along a direction intersecting the press-fitting direction smaller than a width of the second rib along a direction intersecting the press-fitting direction; and
the second rib is formed with a width along a direction intersecting the press-fitting direction larger than a width of the first rib along a direction intersecting the press-fitting direction.

5. The nut press-fitting structure according to claim 1, wherein
the inner wall surface is arranged in a rectangular frame shape when viewed from the press-fitting direction; and
the press-fitting rib is provided on each of the inner wall surfaces located facing each other.

6. The nut press-fitting structure according to claim 2, wherein
the inner wall surface is arranged in a rectangular frame shape when viewed from the press-fitting direction; and
the press-fitting rib is provided on each of the inner wall surfaces located facing each other.
